(19) United States
(12) Patent Application Publication
(10) Pub. No.: US 2003/0000451 A1
(43) Pub. Date: Jan. 2, 2003

(54) Beverage container having thermal indicator

(76) Inventor: Iris Y. Wilcox, Frisco, TX (US)

Correspondence Address: Michael L. Diaz, Michael L. Diaz, P.C., Suite 200, 555 Republic Drive, Plano, TX, 75074, US

(21) Appl. No.: 09/896,581

(22) Filed: Jun. 30, 2001

(51) Int. Cl. G01K 13/00

(52) U.S. Cl. 116/207; 116/216; 374/141

(57) ABSTRACT

A thermal indicator for indicating a specified temperature range of a liquid container within a beverage container. The thermal indicator is constructed of a thermochromic material and affixed to an inner wall of the beverage container. The thermal indicator senses the temperature of the liquid. The thermal indicator changes color upon sensing a selected temperature. The thermal indicator protrudes above the rim of the beverage container to provide an indication to a beverage drinker.

### BACKGROUND OF THE INVENTION

1. Technical Field of the Invention

This invention relates to beverage containers, and more particularly, to a beverage container providing an indication of the temperature of the beverage to a user of the container.

2. Description of Related Art

Many people have difficulty in determining when a hot beverage is safe to drink without the fear of scalding the person's lips and mouth. The person receives the cup of a hot beverage, without knowing how long the beverage will take to cool sufficiently to consume the beverage without burning the person. Typically, the person waits a period of time and then tentatively sips the hot beverage. However, if the person does not wait a sufficient amount of time, the person can still be burned from a very hot beverage. The person then has to repeat this same process of tentative sipping the beverage until the beverage has cooled. Additionally, if the user is involved in another task, such as driving, the entire process of testing the temperature of the beverage can be distracting, and in extreme cases, very dangerous.

Although there are no known prior art teachings of a solution to the aforementioned deficiency and shortcoming such as that disclosed herein, prior art references that discuss subject matter that bears some relation to matters discussed herein are U.S. Pat. No. 3,695,110 to Biolik (Biolik), U.S. Pat. No. 5,678,925 to Garmaise et al. (Garmaise), U.S. Pat. No. 5,720,555 to Elele (Elele), U.S. Pat. No. 5,588,747 to Blevins (Blevins), and PCT Publication Number WO 98/30848 to Garrett et. al (Garrett).

Biolik discloses a temperature measuring device incorporated into a spoon. The spoon includes a handle and a food holding portion adapted for holding food to be eaten. The handle has a recess and a temperature measuring means disposed in the recess and adapted to be read to provide an indication of the temperature of the food held in the food holding portion. However, Biolik does not teach or suggest utilizing the temperature indicating device on a beverage container. Biolik merely discloses incorporating a thermometer with a spoon. Biolik also does not include a thermal reactive strip. Additionally, although Biolik discloses a device for stirring liquids while determining the food's temperature, Biolik suffers from the disadvantage of requiring an extensive and relatively costly modification to an existing spoon.

Garmaise discloses a hot beverage mug automatically sensing the temperature of its liquid contents and generating an accurate aural and visual indication of the temperature sensed. The temperature is sensed by a thermistor in a resistive capacitive (R/C) circuit which operates to yield a signal of variable frequency corresponding to the temperature sensed. An integrated circuit (IC) logic controller treats this electrical signal as an input which triggers an electrical signal from the IC controller to an aural or visual display generating device such as an annunciator or LED display. The power for the R/C circuit, the IC and the aural/visual indicators is supplied from a battery and controllable by a switch activated either manually or automatically upon sensing the pressure of the liquid contents. However, Garmaise suffers from the disadvantage of requiring an integrated circuit and a power source, increasing the overall cost of the container. Additionally, Garmaise requires a specifically modified container for measuring the temperature of the liquid.

Elele discloses a temperature indicating container apparatus which includes an inner container portion made from substantially heat insulative material. The inner container portion includes an inside, material-containing surface and an outside surface. A thermochromic-substance-containing portion is juxtaposed against the outside surface of the inner container portion. When reversible thermochromic substances are employed, the thermochromic-substance-containing portion undergoes one sequence of color changes when the thermochromic-substance-containing portion undergoes rising temperatures, and the thermochromic-substance-containing portion undergoes a reverse sequence of color changes when the thermochromic-substance-containing portion undergoes falling temperatures. The thermochromic-substance-containing portion may be in a form of a jacket around the outside surface of the inner container portion. Although Elele discloses a thermal reactive strip which changes color based on the temperature of the liquid, Elele does not teach or suggest incorporating a thermal reactive strip on an unmodified beverage container. Elele requires the specially constructed container to hold the liquid and read the temperature of the container's contents. In addition, Elele teaches the use of the thermochromic-substance-containing strip being affixed to the outer surface of the beverage container which does not accurately measure the temperature of the liquid. Elele suffers from positioning the strip on the opposite side of the container wall, rather than directly contacting the liquid.

Blevins discloses a measuring cup with a thermometer mounted on an exterior surface for measuring the temperature of a liquid prior to placing it in the cup. The cup may be used in various operations involving a liquid which have a critical temperature requirement. However, Blevins does not teach or suggest a thermal reactive strip for indicating the temperature of the liquid contents or a stirrer for indicating the temperature of the liquid. Additionally, the cup requires extensive modifications for affixing the thermometer to the exterior surface and allow accurate temperature readings of the liquid contained within the cup.

Garrett discloses a chiller for chilling a quantity of fluid having an adsorbent for receiving and adsorbing under pressure a quantity of gas. The desorption of gas from the absorption causes a reduction in temperature of the adsorbent and adsorbate which acts to chill the fluid. The chiller includes a thin-walled vessel for placement in direct thermal contact with the fluid to be chilled wherein the vessel having two thin sheets of substantially similar size and shape, joined together around the peripheral edges so as to form a cavity for containing the adsorbent. The chiller is suitable for chilling a can. The can may be provided with means to give a visual indication of the temperature of the beverage. Although Garret discloses the container having a thermochromatic indicator to provide a visual indication as to when the chilling operation has been completed, Garrett does not disclose utilizing the thermochromatic indicator on an unmodified beverage container. Additionally, Garrett does not teach or suggest positioning the indicator on the interior of the beverage for an accurate reading of the temperature of the beverage.

Review of the foregoing references reveals no disclosure or suggestion of an apparatus as that described and claimed herein. Thus, it would be a distinct advantage to have a thermal indicator which requires no extensive modification to a beverage container and provides accurate temperature indications to the user. It is an object of the present invention to provide such an apparatus.

### SUMMARY OF THE INVENTION

In one aspect, the present invention is a beverage container for indicating to a user a temperature of a liquid contained within the beverage container. The beverage container includes a container having an interior portion holding the liquid. The container includes an inner wall surrounding the liquid within the interior portion. In addition, the container includes a thermochromic strip affixed to the inner wall of the container and contacting the liquid. The thermochromic strip protrudes upwardly above a top surface of the liquid, such that the thermochromic strip displays a display portion of the strip to the user. The display portion of the thermochromic strip changes to a specific color when a selected temperature of the liquid has been attained.

In another aspect, the present invention is a beverage container for indicating to a user a temperature of a liquid contained within the beverage container. The container includes a container having an interior portion holding the liquid. The container has an inner wall surrounding the liquid within the interior portion. In addition, the beverage container includes a thermochromic strip located adjacent the inner wall of the container while contacting the liquid. The thermochromic strip protrudes upwardly above a top surface of the liquid, such that the thermochromic strip displays a display portion of the strip to the user and the display portion curls downwardly outside the container. The display portion of the thermochromic strip changes to a specific color when the liquid has cooled to a specific temperature tolerable for drinking without causing discomfort to the user.

In still another aspect, the present invention is a beverage container for indicating to a user a temperature of a liquid contained within the beverage container. The container includes a container having an interior portion holding the liquid and a stir stick having a thermochromic strip. The stir stick is positioned within the interior portion of the beverage container and contacts the liquid, the thermochromic strip changing to a specified color when a desired temperature of the liquid is attained.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front perspective view of a beverage container having a liquid located within an interior area of the container in the preferred embodiment of the present invention;

FIG. 2 illustrates the thermal strip of FIG. 1 removed from the beverage container;

FIG. 3 is a front perspective view of a stir stick in the beverage container in an alternate embodiment of the present invention; and

FIG. 4 is a side view of the stir stick of FIG. 3 removed from the beverage container.

### DETAILED DESCRIPTION OF EMBODIMENTS

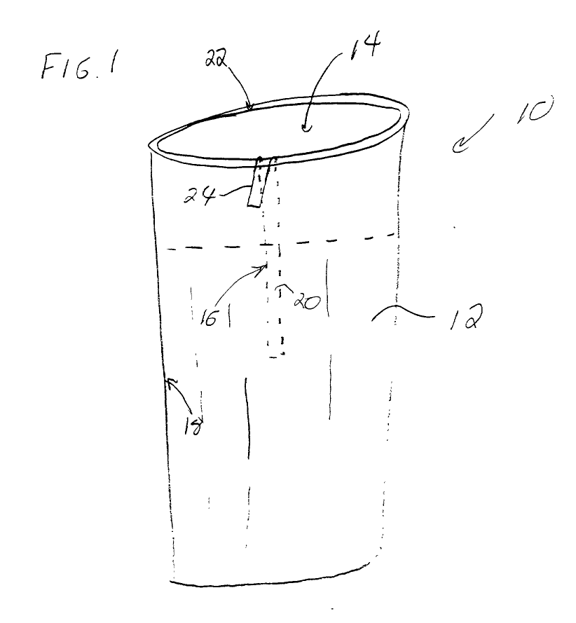

A beverage container having a thermal indicator is disclosed. FIG. 1 is a front perspective view of a beverage container 10 having a liquid 12 located within an interior area 14 of the container in the preferred embodiment of the present invention. A thermal strip 16 is positioned within the interior area 14 against an inner surface 18 of the beverage container.

The container 10 may take any shape or size. As illustrated, the thermal strip is affixed to a conventional container. The container requires no modification for affixing the thermal strip to the inner surface 18 of the container.

The thermal strip 16 is a strip of thermochromic material responding to sensed temperature changes. The thermochromic material may be constructed to display various colors for selected temperature ranges. In the preferred embodiment of the present invention, the thermal strip changes to specified colors when specific temperature ranges are attained. For example, if the thermal indicator senses a temperature greater than a selected temperature, such as 70 degrees Celsius, the thermal strip may change to a red color. If the thermal strips senses a temperature below 70 degrees Celsius, the thermal strip may change to a different color, such as green. In the preferred embodiment of the present invention, the thermal strip changes to a selected color, such as green, to indicate that the thermal strip senses a sufficiently cooled liquid temperature, allowing a user of the beverage container to drink the liquid without fear of burning the user's mouth.

The thermal strip 16 is affixed to the inner surface 18 of the beverage container 10 by any means allowing the thermal strip to remain in position with liquid located within the interior area 14 of the beverage container. For example, the thermal strip may be affixed by an adhesive bond to the inner surface of the beverage container. In another embodiment of the present invention, the strip may be embedding into the inner surface of the beverage container. The thermal strip includes a sensor section 20 located within the interior area. The sensor section is exposed to the liquid contained within the interior area of the container. Since the sensor section is directly exposed to the liquid, the thermal strip provides a more accurate indication of the temperature range of the liquid.

The thermal strip protrudes over a rim 22 of the beverage container. In the preferred embodiment of the present invention, the protruding portion of the thermal strip curls downwardly. The protruding portion of the thermal strip exhibits a display portion 24 of the thermal strip. The display portion exhibits the various colors associated with the sensed temperature ranges of the sensor section 20 of the thermal strip. The colors may be a neutral or red color to indicate that the sensor section senses a hot beverage, which would not be acceptable for drinking. In the preferred embodiment of the present invention, the display portion eventually changes to another color (e.g., green), to indicate that the senses liquid has cooled below a selected temperature. In an alternate embodiment of the present invention, the display section may also include a section of material which glows when a selected temperature is reached to indicate to the user at night that the liquid has cooled sufficiently.

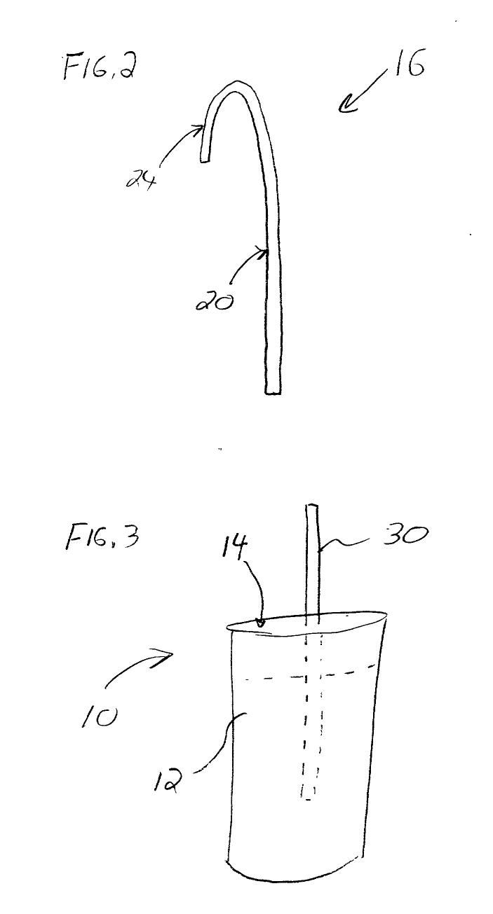

FIG. 2 illustrates the thermal strip 16 of FIG. 1 removed from the beverage container 10. The thermal strip may be sized and shaped to accommodate various sizes and shapes of the beverage container. Although a rectangular strip is illustrated, the thermal strip may be shaped in any fashion to allow the thermal strip to be exposed to the liquid while exhibiting the display section 24 to the user of the beverage container 10. However, it should be understood that the protruding portion of the thermal strip may be extended in any direction which allows the user to read the thermal strip.

With reference to FIGS. 1 and 2, the operation of the thermal strip 16 within the beverage container 10 will now be explained. The thermal strip is preferably embedded on the inner surface 18 of the container 10. The heated liquid 12 is poured into the beverage container. The sensor section of the thermal strip is exposed to the heated liquid. The thermal strip is constructed of the thermochromic material. The thermochromic material provides an indication of a satisfactorily cooled beverage. For example, if it is determined that the beverage is cooled when the liquid has cooled below 70 degrees Celsius, the thermal strip may be constructed in such a fashion as to turn to a selected color when the liquid has dropped at or below 70 degrees Celsius. The sensed temperature of the liquid is converted to the specified color on the display section 24 of the thermal strip. Since the display section is located outside the beverage container, the color of the thermal strip may be easily seen by a beverage drinker. When the liquid has cooled, the drinker is provided with the indication of the cooled liquid. Once the liquid has sufficiently cooled, as indicated by the display section, the drinker may drink the liquid without risk of burning his mouth. Alternatively, the thermal strip may also glow when a specific temperature is reached, indicating to the beverage drinker the temperature range of the liquid at nighttime. In still another alternate embodiment, the thermal strip may glow until a specific temperature is attained. It should be understood that any temperature range may be selected which provides an adequate and desirable temperature for the user. Although 70 degrees Celsius has been used as a desired temperature, any temperature range may be selected and associated with a specific color. Additionally, in an alternate embodiment of the present invention, the thermal strip may indicate when the liquid 12 is sufficiently heated to a particular temperature.

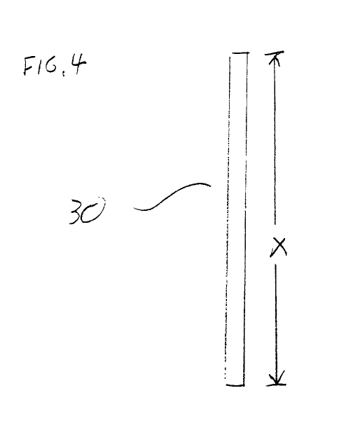

FIG. 3 is a front perspective view of a stir stick 30 in the beverage container 10 in an alternate embodiment of the present invention. The stir stick performs the same function as the thermal strip 16 discussed in FIG. 1. The stir stick is constructed of a thermochromic material, changing colors to indicate various sensed temperature ranges. Preferably the stir stick displays colors across the entire length of the stir stick. However, alternatively, the stir stick may display only a portion or portions colors across the length of the stir stick having displayed colors. The stir stick may also be used as a conventional stirrer for stirring the liquid within the beverage container.

FIG. 4 is a side view of the stir stick 30 of FIG. 3 removed from the beverage container. The stir stick is preferably shaped as a conventional stir stick common in use within the beverage industry. The stir stick has a length X which is preferably greater than the height of the beverage container 10. The stir stick may also incorporate a material which glows upon reaching a specific temperature range to indicate to a user at night when the liquid attains the desired temperature. The stir stick is different from the thermal strip 16 of FIG. 1 in that the stir stick is not affixed to the beverage container 10.

With reference to FIGS. 3 and 4, the operation of the stir stick 30 within the beverage container 10 will now be explained. The heated liquid 12 is poured within the interior area 14 of the beverage container. The beverage drinker can then position the stir stick within the liquid. The stir stick, while contacting the liquid, senses the temperature of the liquid, providing an indication of the sensed temperature range. For example, if the temperature is above 70 degrees Celsius, the stir stick may indicate a red color. When the liquid has cooled below 70 degrees, the stir stick may indicate a separate color, such as green, indicating to the beverage drinker that the liquid has cooled sufficiently. Additionally, if a specific desired temperature is reached, the stir stick may start or stop glowing, providing an indication of the temperature of the liquid at night. Although 70 degrees Celsius is discussed as a desired temperature, any desired temperature may be selected by a manufacturer of the stir stick for which the stir stick changes to a particular color.

In still another embodiment of the present invention, the strip may be replaced by a stir stick which changes colors. The stir stick may be placed within the hot liquid 12. When the stir stick changes to a specific color (e.g., green), the liquid is at an acceptable temperature to drink.

The thermal indicator for use in a hot beverage provides many benefits. A person no longer has to test the liquid to determine if the liquid has cooled sufficiently. Additionally, since the liquid will not be consumed until the thermal strip indicates that the liquid is cool, the person will not accidentally burn himself when consuming the liquid. Additionally, by providing a simple and effective indicator for the person to determine if the liquid is adequately cooled, the person's attention is not diverted from other more important tasks, such as driving. The thermal indicator also does not require any costly modifications to beverage containers. Since the thermal indicator is directly exposed to the liquid held in the container, the thermal indicator more accurately senses the temperature of the liquid.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A beverage container for indicating to a user a temperature of a liquid contained within the beverage container, said container comprising:
a container having an interior portion holding the liquid, said container having an inner wall surrounding the liquid within the interior portion;
a thermochromic strip affixed to the inner wall of said container and contacting the liquid, said thermochromic strip protruding upwardly above a top surface of the liquid, such that said thermochromic strip displays a display portion of the strip to the user;
whereby the display portion of said thermochromic strip changes to a specific color when a selected temperature of the liquid has been attained.

2. The beverage container of claim 1 wherein the display portion of the thermochromic strip curls downwardly outside said container.

3. The beverage container of claim 1 wherein said thermochromic strip is affixed with an adhesive bond to the inner wall of said container.

4. The beverage container of claim 1 wherein said thermochromic strip is embedded into the inner wall of said container.

5. The beverage container of claim 1 wherein said display portion glows when a specific temperature of the liquid has been attained.

6. The beverage container of claim 1 wherein said display portion glows until a specific temperature of the liquid has been attained.

7. The beverage container of claim 1 wherein said thermochromic strip changes color when the liquid has cooled to a specified temperature tolerable for drinking by the user of the beverage container.

8. The beverage container of claim 1 wherein said thermochromic strip changes color when the liquid has heated to a specified temperature desired by the user of the beverage container.

9. A beverage container for indicating to a user a temperature of a liquid contained within the beverage container, said container comprising:
a container having an interior portion holding the liquid, said container having an inner wall surrounding the liquid within the interior portion;
a thermochromic strip located adjacent the inner wall of said container while contacting the liquid, said thermochromic strip protruding upwardly above a top surface of the liquid, such that said thermochromic strip displays a display portion of the strip to the user and said display portion curls downwardly outside said container;
whereby the display portion of said thermochromic strip changes to a specific color when the liquid has cooled to a specific temperature tolerable for drinking without causing discomfort to the user.

10. A beverage container for indicating to a user a temperature of a liquid contained within the beverage container, said container comprising:
a container having an interior portion holding the liquid;
a stir stick having a thermochromic strip;
whereby said stir stick is positioned within the interior portion of the beverage container and contacting the liquid, the thermochromic strip changing to a specified color when a desired temperature of the liquid is attained.

11. The beverage container of claim 10 wherein the stir stick is used as a conventional stirrer for the liquid.

12. The beverage container of claim 10 wherein the stir stick glows when the desired temperature is attained.

13. The beverage container of claim 10 wherein the stir stick glows until a desired temperature is attained.
